(19) United States
(12) Patent Application Publication
(10) Pub. No.: US 2014/0006396 A1
(43) Pub. Date: Jan. 2, 2014

(54) CUSTOMIZED PRINT ON DEMAND PERSONALIZED CATALOGUE METHOD AND SYSTEM

(71) Applicants: Mark R. Patenaude, Greely (CA); Nevin Maurice, Orleans (CA); David Wilson, Ottawa (CA); Brian Boulter, Ottawa (CA)

(72) Inventors: Mark R. Patenaude, Greely (CA); Nevin Maurice, Orleans (CA); David Wilson, Ottawa (CA); Brian Boulter, Ottawa (CA)

(73) Assignee: ST. JOSPEH PRINT GROUP, INC., Ottawa, ON (CA)

(21) Appl. No.: 13/811,349

(22) PCT Filed: Jul. 18, 2011
(86) PCT No.: PCT/CA2011/050440

§ 371 Date: Aug. 1, 2013

Related U.S. Application Data
(60) Provisional application No. 61/365,414, filed on Jul. 19, 2010.

(51) Int. Cl. G06F 17/30

(52) U.S. Cl. CPC G06F 17/30424
USPC 707/732

(57) ABSTRACT

There is provided a system and method for providing a customized, personalized print on demand catalogue. The system and method provide for the production of customized catalogues based on customer's preferences wherein a catalogue template is populated with assets that match a customer's preferences thereby producing a customized, personalized print on demand catalogue.

### FIELD OF THE INVENTION

This invention pertains to the field of catalogue or brochure printing and in particular, to a customized print on demand personalized catalogue method and system.

### BACKGROUND OF THE INVENTION

Traditional catalogues and brochures display information relevant to many segments of its target audience. For example, university and college calendars often include a listing of all available courses. Product catalogues and tourist brochures generally include listing of a wide range of products and attractions respectively. As a result, much of the information included in these traditional catalogues or brochures is either not relevant or not of interest to a particular individual or group of individuals to which the catalogue or brochure is targeted.

The inclusion of non-relevant information in traditional catalogues and brochures results in larger documents that require more resources and costs to manufacture and are less amendable to target audience review or shipping. Alternatively if the size of the document is limited, the amount of information available on a particular product or attraction may be reduced or only a selection of product or attraction choices may be presented in the catalogue or brochure.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a customized print on demand personalized catalogue system and method. In accordance with an aspect of the present invention, there is provided a method of preparing a customized, personalized print on demand catalogue, the method comprising providing a plurality of catalogue assets, wherein each of the catalogue assets is an image, graphic, text or combination thereof for insertion into a catalogue template; providing a catalogue template; receiving from a particular customer a request for a personalized catalogue, wherein the request includes at least one customer preference; searching the plurality of catalogue assets for assets that match the particular customer's preferences; populating the catalogue template with the assets that match the particular customer's preferences thereby producing a customized, personalized print on demand catalogue.

In accordance with another aspect of the invention, there is provided a customized, personalized print on demand catalogue system comprising a server operatively associated with a network comprising a database having a plurality of catalogue assets, wherein each of the catalogue assets is an image, graphic, text or combination thereof for insertion into a catalogue template; a catalogue template; a customer database comprising a plurality of customer profiles; an asset management tool configured to search the plurality of catalogue assets for assets that match the particular customer's preferences and populate the catalogue template with the assets that match the particular customer's preferences to produce a customized, personalized catalogue order; an order database operatively associated with the asset management tool for storing a plurality of customized, personalized catalogue orders; and at least one customer interface operatively associated with the server for the input of customer profile information and configured for catalogue ordering; an integrated database management system operatively associated with the order database and a print engine to manage printing of the customized, personalized print on demand catalogues; wherein the print engine picks up catalogue orders, builds the catalogue and fills print queues.

### BRIEF DESCRIPTION OF THE DRAWINGS

These and other features of the invention will become more apparent in the following detailed description in which reference is made to the appended drawings.

FIG. 1 is a flow chart representing steps in building a customized print on demand personalized catalogue.

FIG. 2 is a flow chart representing the components of one embodiment of the customized print on demand personalized catalogue system.

FIG. 3A to C shows an example of a client interface for the application of the method and system to a college or university handbook.

### DETAILED DESCRIPTION OF THE INVENTION

There is provided a method and system for preparing a customized print on demand personalized catalogue containing custom selected information and/or pages from a larger generic catalogue. The selected information and/or pages are focused on the ordering individual's specific preferences determined, at least in part, from input from the individual. Optionally, the system and method may further comprises a means for suggesting or recommending or targeting content based on the individual's input or customer profile or based on the preferences of individuals with like or similar profiles or individuals in the same social group.

A front end application, which can either be a website or the like or a local stand alone application, acts as an interface for the input of information. Optionally, input of information may be facilitated by query questions being asked and voluntarily replied to by the client. Other or additional information may be provided by the organization or institution producing the catalog. Based on the input, a customized, personalized catalog can be generated. For example, variable print, pictures, text languages can be applied based on the specific answers to multiple questions or the customer's profile to enhance the customer experience in viewing the catalog. Additional personalized information can include name, address, price, language, greetings etc. In some, embodiments, the client is provided the opportunity to review, accept and reject content either as it is added to the catalog template or prior to the catalog order being finalized.

The system and method further provide for the e-publishing of the finalized catalogue. Customers can optionally view a PDF copy or other appropriate format of their finalized catalogue immediately after it is generated. An electronic version of the finalized catalogue can optionally be forwarded to the client and/or stored for remote access. Electronic versions of the catalogue are optionally searchable. The client may, either automatically or upon request receive, a high quality printed copy. The request to receive a high quality printed copy may be inputted via the front end application.

The method and system provides for the completely automated production of customized, personalized catalogues.

Customized print on demand personalized catalogue are ideally suited for a variety industries and applications. For example, universities and colleges utilitizing the methods and system can provide customized course material with prices, timetables and in various languages that replaces their current multiple page Calendars.

Tourism commissions, tour operators, cruise lines, travel agents and the like, using these systems and methods can produce tourism booklets or brochures that display information relating to what a specific client may want to visit at a specific destination and optionally detail special events shown occurring during the period they are visiting and/or include a specific client's itinerary and/or tickets and/or coupons. In addition based on client preferences or profile, advertisements which are specifically targeted to the individual can be included in the catalogue.

Associations whereby a member could build the information he/she is interested in. Similarly, this method and system provides conference and event attendees the option to produce a personalized conference programs.

Memberships organizations such as Scouts that would deliver to a prospect an application and booklet that mixes the local leadership, location, practices, leadership, costs, languages etc.

Manufacturers and retailers using these systems, manufacturers and retailers can produce specifically targeted catalogues to meet a client's needs.

An organization or institution interested in providing customized print on demand personalized catalogues provide a catalogue template that includes any information relevant to all individuals to which the catalogue is target and a plurality of catalogue assets including image, graphic or text that can be used to populated the catalogue template. The catalogue assets may be in the form of a full catalog page, multiple catalog pages or part or fraction of a single page. Multiple part pages or page fractions can be combined to form a single page or may be inserted into a blank single page. In one embodiment, the assets can include advertisements for specifically targeted segments of the catalogue's audience. The catalogue assets form a searchable database. This database and the assets within it can be updated in realtime and optionally catalogue orders may be updated automatically to include the most up-to-date information and assets. Ordering individuals can optionally receive an alert or notification indicating that there has been an update. In some embodiments, either an updated catalogue or updated pages are made available to the ordering individual automatically.

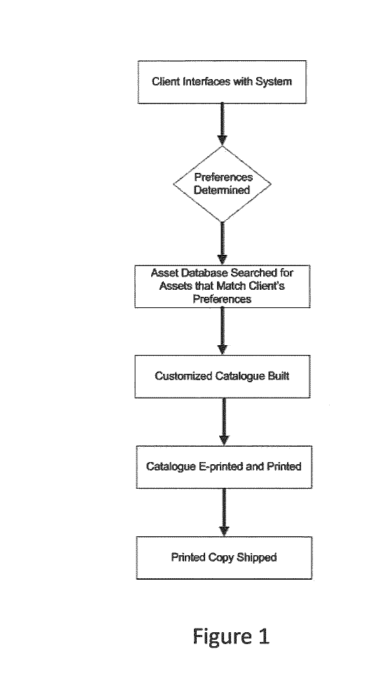

Referring to FIG. 1, in order to produce a personalized catalogue, a client interfaces with the system and enters relevant information. Relevant information may be dependent on the type of catalogue or brochure being generated and can include demographic information including sex, race, age, income, disabilities, mobility, number of dependents, educational attainment, home ownership, employment status, and location, etc., details with respect to hobbies, specific areas of interest, political affiliations, organizational membership, magazine subscriptions, among other things. Relevant information may further include information relating to the format and look of the catalogue, including language, font, colour selection and the like. For an academic application, the relevant information may include area of study, academic year, grade point average, parental income, among others.

Optionally, through a series of questions and/or prompts, the system may extract the necessary information from the client and may be presented in the form of written answer question, multiple choice questions, selection form lists, rankings among others. Client answers to one or more questions may trigger further more specific questions. Questions and prompts are designed to identify client preferences and/or generate a client profile. The database of catalogue assets is searched for assets consistent with the client's preference and these are used to populate the catalogue template thereby producing a customized, personalized print on demand catalogue. Other appropriate assets may be identified based on assets that have been shown to be of interest to other individuals with like or similar profiles.

Client preference information is optionally stored in a database and used to identify assets that are likely of interests to individual's with specific characteristics or interests.

The personalized catalogue may be e-published and/or printed.

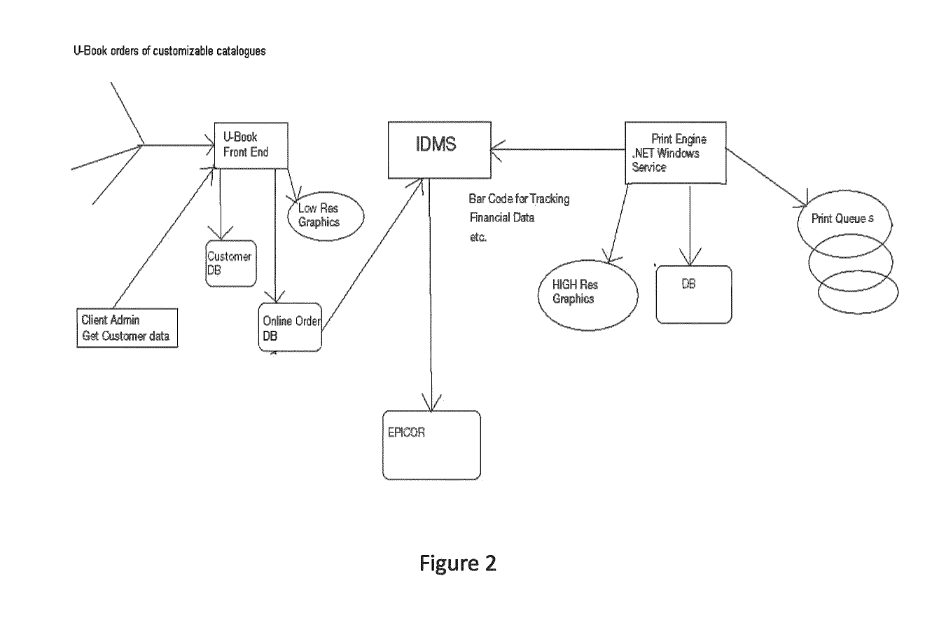

FIG. 2 illustrates a block diagram of a customized print on demand personalized catalogue system in accordance with one embodiment of the present invention. The POD personalized catalogue system is a multi-component system comprising a number of communicatively coupled and interacting components or subsystems. The system comprises a front end or user interface operatively associated with a customer database and order database. The user interface is operable to allow a customer or client to communicate with the system and enter relevant information into the customer database and facilitate the ordering of the customized catalogue. The customer database may be partially or fully pre-populated with relevant information by a third party. Third parties may include administrators, registrars, tour operators among others. Information that third parties add may be obtained from registration forms, applications, membership forms and the like.

The system comprises several databases including a customer database, order database which in one embodiment is a sub-database of customer database and a content database that includes data packets or assets or links thereto for populating the customized catalogue template to produce the finished customized catalogue or brochure. The customized catalogue or brochure template includes information relevant to all individuals to which the customized catalogue or brochure is targeted to.

Individual customers and/or customized catalogues may be assigned an unique identifier to facilitate tracking. In one embodiment, the unique identifier is a bar code. The bar code may be added during customized catalogue design or printed separately and affixed to the catalogue at the time of printing.

In another embodiment, the unique identifier is a smart label or RFID tag.

The finished customized catalogue order is stored in the order database for retrieval either by the customer, the catalogue owner or the print engine. Management of printing of the customized catalog is optionally provided for by an integrated database management system. Printing of the finished customized catalog can either automatically triggered or triggered by the client or by the customer.

Optionally, the system may be linked to a financial system to facilitate billing.

To gain a better understanding of the invention described herein, the following examples are set forth. It will be understood that these examples are intended to describe illustrative embodiments of the invention and are not intended to limit the scope of the invention in any way.

### EXAMPLES

### Example 1

### Process for Preparing Customized Catalog from Assets in the Form of PDF Source Files

In one embodiment, assets are in the form of source PDF files. These files are given unique filenames which are registered in a database. These PDF files are stored on a server, each file representing a single page in a customized catalog. Each PDF can be pulled from storage using the filename, by running queries on the database.

Custom programming logic plugs into the print engine which contains all the tools for building customized catalog. The correct PDF files are selected from storage based on the client's preference in the proper order. As necessary, pages are modified with overprint using the correct fonts, colors, sizes and co-ordinates. Images are modified or resized and plugged in at the proper co-ordinates within the template. Personalized information is added and can include address information along with a unique bar code so it can be scanned, tracked, and billed for later. Individual PDF pages are concatenated into a single larger PDF document thereby producing the customized catalogue. The finished PDF is loaded into the print queue for printing on a high quality color printer.

### Example 2

### Personalized College or University Handbook

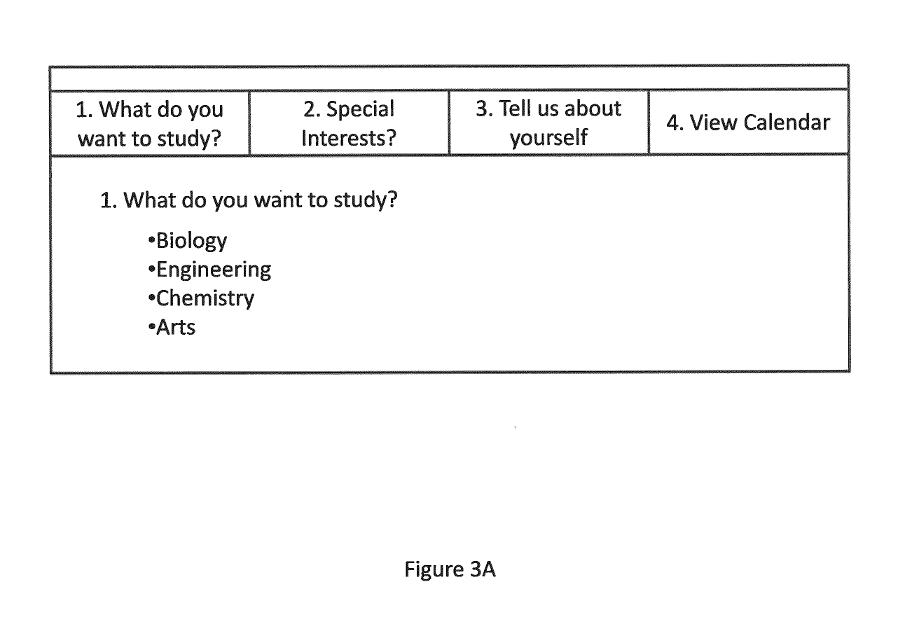

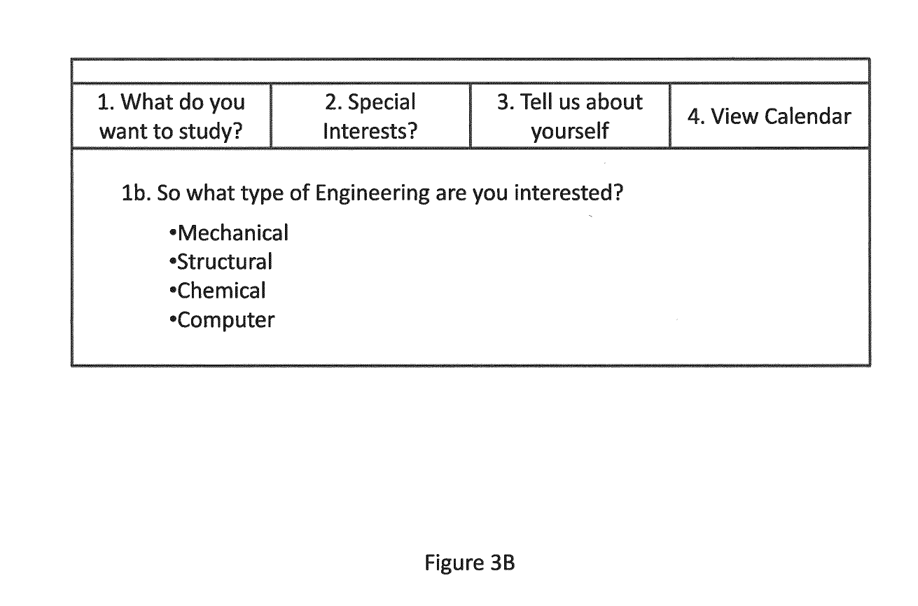

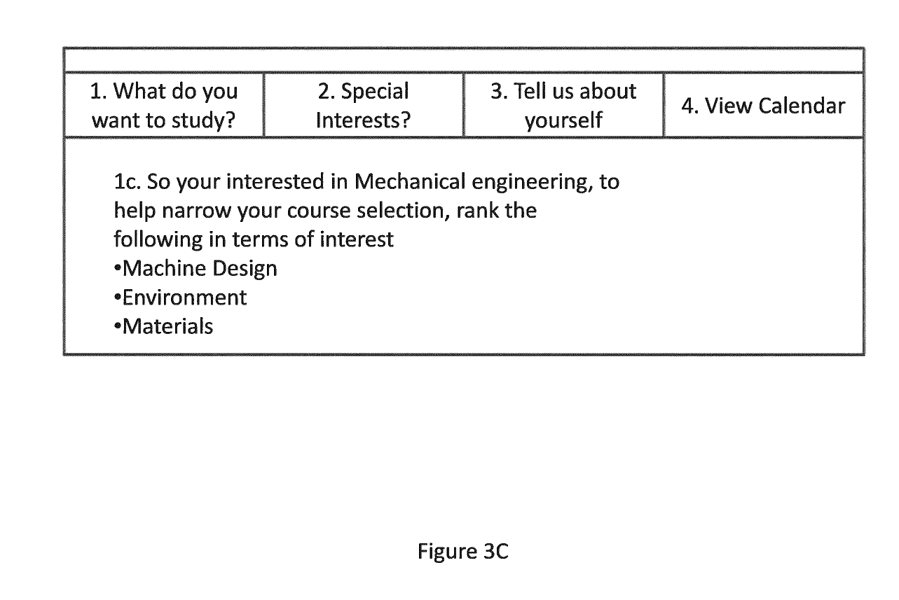

In one embodiment and with reference to FIG. 3, to produce a personalized college handbook, a student or potential student accesses the system via an on-line interface. Using a series of questions, relevant information is obtained.

In the illustrated embodiment, the interface prompts the student to identify what they what to study and what type of degree they are interested in obtaining. Based on this information, the interfaces provides a list of courses that may be of interest to the student. In some embodiment, the student may be able to rank courses based on level of interest. The list of courses may be first pre-filter to include only those courses for which they are eligible to take (i.e. have the necessary prerequisites and in the correct program). The interface then prompts the student to identify special interests. Determination of special interests may be facilitated by a serial listing of question. For example, if the student identifies “Sports and Recreation” as an area interest, the interface may then prompt the student to identify if they are interested in intra-mural sports, competitive sports, individual sports, team sports etc. Based on the answers to this second level of question, a further level of more specific question may be provided to refine the area interest and therefore provide more specifically targeted information.

Assets for insertion into college or university handbooks may optionally include information that is dependent on previous academic performance. For example, scholarship information would only be included in the handbooks that are eligible to apply.

Once the student's preferences are determined, the order is completed by identifying appropriate assets and compiling these assets to produce the customized handbook.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

We claim:

1. A method of preparing a customized, personalized print on demand catalogue, the method comprising:
providing a plurality of catalogue assets, wherein each of the catalogue assets is an image, graphic, text or combination thereof for insertion into a catalogue;
providing a catalogue template;
receiving from a particular customer a request for a personalized catalogue, wherein the request includes at least one customer preference;
searching the plurality of catalogue assets for assets that match the particular customer's preferences;
populating the catalogue template with the assets that match the particular customer's preferences thereby producing a customized, personalized print on demand catalogue.

2. The method of claim 1, further comprising printing the customized, personalized print on demand catalogue.

3. The method of claim 2, wherein the customized, personalized print on demand catalogue comprises a unique identifier for tracking the catalogue.

4. The method of claim 3, wherein the unique identifier is a bar code, smart label or RFID tag.

5. The method of claim 3 or 4, comprising scanning the unique identifier.

6. The method of claim 1, wherein searching the plurality of catalogue assets for assets that match the particular customer's preferences comprises the step of determining customer's preferences from customer profile information.

7. The method of claim 1, searching the plurality of catalogue assets for assets that match the particular customer's preferences comprises the step of identifying assets that were of interest to individuals with a like or similar profile.

8. The method of claim 6, wherein the customer profile is a multi-level profile and catalogue assets are categorized as being general interest assets or specific interest assets.

9. A customized, personalized print on demand catalogue system comprising:
a server operatively associated with a network comprising:
a database having a plurality of catalogue assets, wherein each of the catalogue assets is an image, graphic or text for insertion into a catalogue template;
a catalogue template;
a customer database comprising a plurality of customer profiles;
a asset management tool configured to search the plurality of catalogue assets for assets that match the particular customer's preferences and populate the catalogue template with the assets that match the particular customer's preferences to produce a customized, personalized print on demand catalogue order;
an order database operatively associated with the asset management tool for storing a plurality of customized, personalized print on demand catalogue orders; and
at least one customer interface operatively associated with the server for the input of customer profile information into the customer database and the asset management tool and the order database to manage catalogue orders into the on-line order database;
an integrated database management system operatively associated with the on-line order database and a print engine; and
a print engine to manage printing of the customized, personalized print on demand catalogues;
wherein the print engine picks up catalogue orders, builds the catalogue and fills print queues.
